(19) United States
(12) Patent Application Publication
(10) Pub. No.: US 2011/0154209 A1
(43) Pub. Date: Jun. 23, 2011

(54) PLATFORM FOR PROACTIVE DISCOVERY AND DELIVERY OF PERSONALIZED CONTENT TO TARGETED ENTERPRISE USERS

(75) Inventors: James FAN, San Ramon, CA (US); Richard KUO, Mountain View, CA (US); Tye SCHRIEVER, Sammamish, WA (US); Deva-Datta SHARMA, San Ramon, CA (US)

(73) Assignee: AT&T INTELLECTUAL PROPERTY I, L.P., Reno, NV (US)

(21) Appl. No.: 12/644,456

(22) Filed: Dec. 22, 2009

(51) Int. Cl. G06F 17/30; G06F 3/048

(52) U.S. Cl. 715/736; 707/609; 707/E17.059; 707/784; 707/E17.005; 707/E17.032

(57) ABSTRACT

Obtaining content by an enterprise knowledge management system includes monitoring at least one of an enterprise repository data store, an intranet, a local repository data store, the Internet and subscription-based sources to obtain data relevant to an enterprise profile. The data is categorized, tagged and indexed for storage in the enterprise repository data store. Content selected based on a user profile, and obtained from the enterprise repository data store, is pushed to a user terminal.

### BACKGROUND

1. Field of the Disclosure

The present application relates to information sharing and information acquisition. More particularly, the present application relates to systems and methods for proactive discovery and delivery of personalized content to targeted enterprise users.

2. Background Information

Members of an organization typically author and store a number of documents, presentations and project plans. These documents are stored in disparate locations such as local hard drives, networked drives, portable devices, and shared servers. Sometimes, information may be embedded in emails. Members of a project team may need to access a common subset of these documents and further, may require similar access capabilities to these documents.

### BRIEF DESCRIPTION OF THE DRAWINGS

FIG. 1 shows an exemplary general computer system that includes a set of instructions for proactive discovery and delivery of personalized content to targeted enterprise users;

FIG. 2a shows a system diagram illustrating data flow between components involved in creating an enterprise knowledge base repository, according to an aspect of the present disclosure;

FIG. 2b shows a system diagram for using the enterprise knowledge base repository with a personal knowledge base repository, according to an aspect of the present disclosure;

FIG. 2c is a system diagram that illustrates publishing content to an area available to the public, according to an aspect of the present disclosure;

FIG. 3 shows a research integration tool and store as integrated in an enterprise knowledge management system, according to an aspect of the present disclosure;

FIG. 4 illustrates a process flow diagram for a first exemplary use of components of the enterprise knowledge management system;

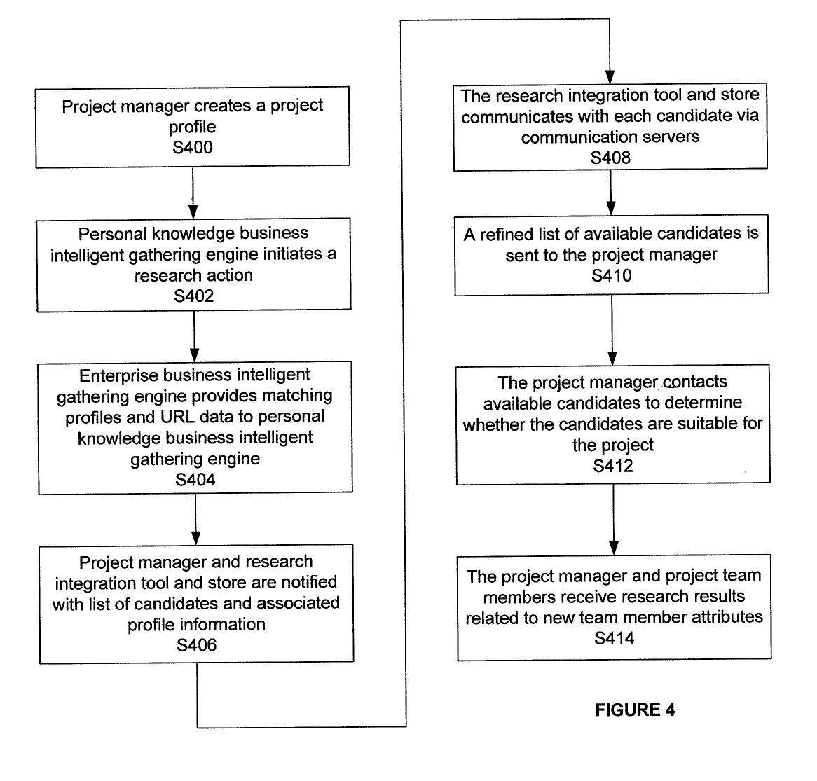

FIG. 5 illustrates a process flow diagram for a second exemplary use of components of the enterprise knowledge management system;

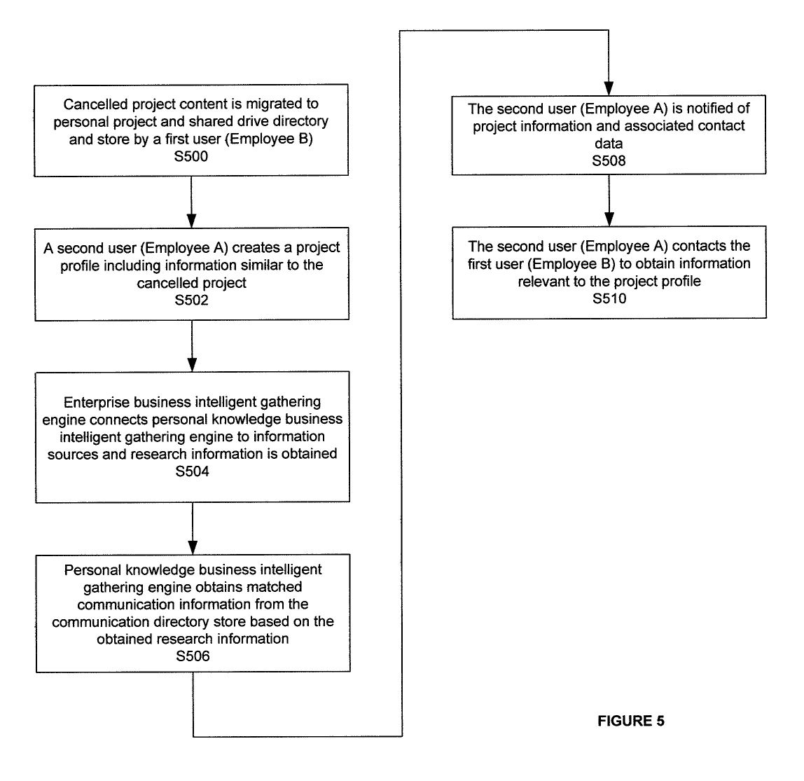

FIG. 6 illustrates a process flow diagram for a third exemplary use of components of the enterprise knowledge management system; and

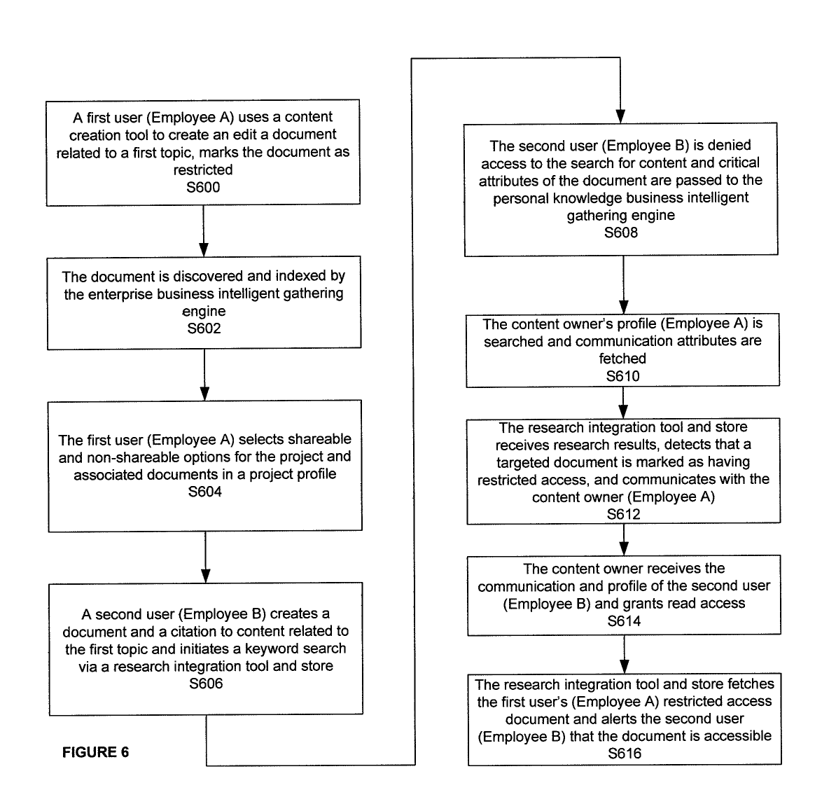

FIG. 7 illustrates a process flow diagram for a fourth exemplary use of components of the enterprise knowledge management system.

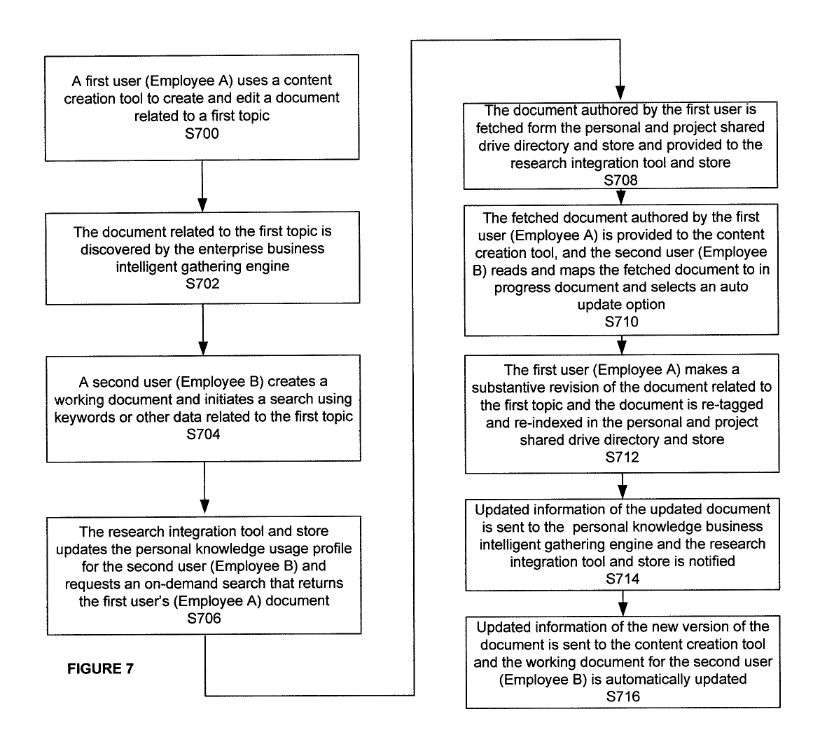

### DETAILED DESCRIPTION

In view of the foregoing, the present disclosure, through one or more of its various aspects, embodiments and/or specific features or sub-components, is thus intended to bring out one or more of the advantages as specifically noted below.

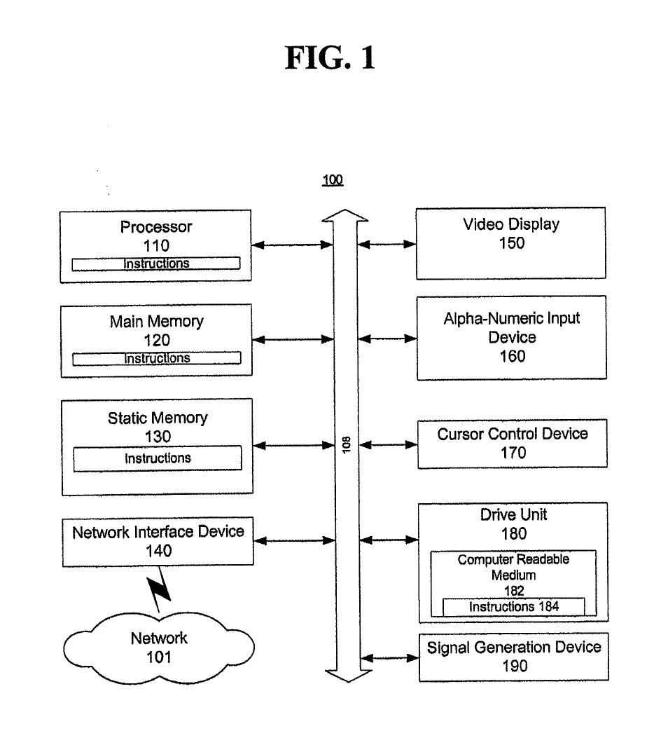

FIG. 1 is an illustrative embodiment of a general computer system, on which a method to provide proactive discovery and delivery of personalized content to targeted enterprise users can be implemented, which is shown and is designated 100. The computer system 100 can include a set of instructions that can be executed to cause the computer system 100 to perform any one or more of the methods or computer based functions disclosed herein. The computer system 100 may operate as a standalone device or may be connected, for example, using a network 101, to other computer systems or peripheral devices.

In a networked deployment, the computer system may operate in the capacity of a server or as a client user computer in a server-client user network environment, or as a peer computer system in a peer-to-peer (or distributed) network environment. The computer system 100 can also be implemented as or incorporated into various devices, such as a personal computer (PC), a tablet PC, a set-top box (STB), a personal digital assistant (PDA), a mobile device, a global positioning satellite (GPS) device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 100 can be implemented using electronic devices that provide voice, video or data communication. Further, while a single computer system 100 is illustrated, the term “system” shall also be taken to include any collection of systems or sub-systems that individually or jointly execute a set, or multiple sets, of instructions to perform one or more computer functions.

As illustrated in FIG. 1, the computer system 100 may include a processor 110, for example, a central processing unit (CPU), a graphics processing unit (GPU), or both. Moreover, the computer system 100 can include a main memory 120 and a static memory 130 that can communicate with each other via a bus 108. As shown, the computer system 100 may further include a video display unit 150, such as a liquid crystal display (LCD), an organic light emitting diode (OLED), a flat panel display, a solid state display, or a cathode ray tube (CRT). Additionally, the computer system 100 may include an input device 160, such as a keyboard, and a cursor control device 170, such as a mouse. The computer system 100 can also include a disk drive unit 180, a signal generation device 190, such as a speaker or remote control, and a network interface device 140.

In a particular embodiment, as depicted in FIG. 1, the disk drive unit 180 may include a computer-readable medium 182 in which one or more sets of instructions 184, e.g. software, can be embedded. A computer-readable medium 182 is a tangible article of manufacture, from which sets of instructions 184 can be read. Further, the instructions 184 may embody one or more of the methods or logic as described herein. In a particular embodiment, the instructions 184 may reside completely, or at least partially, within the main memory 120, the static memory 130, and/or within the processor 110 during execution by the computer system 100. The main memory 120 and the processor 110 also may include computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium 182 that includes instructions 184 or receives and executes instructions 184 responsive to a propagated signal, so that a device connected to a network 101 can communicate voice, video or data over the network 101. Further, the instructions 184 may be transmitted or received over the network 101 via the network interface device 140.

According to one aspect of the present application, a method of obtaining content by an enterprise knowledge management system includes monitoring at least one of an enterprise repository data store, an intranet, a local repository data store, the Internet and subscription-based sources to obtain data relevant to an enterprise profile. The method includes categorizing, tagging and indexing the data for storage in the enterprise repository data store. The method also includes pushing content selected based on a user profile, and obtained from the enterprise repository data store, to a user terminal.

According to another aspect of the present application, the user profile is automatically generated and the user profile is based on a job description and contact information for a user.

According to yet another aspect of the present application, the user profile is customizable by a user.

According to still another aspect of the present application, the method includes displaying the content, as part of a graphical user interface, on the user terminal.

According to an aspect of the present application, a subset of attributes of the user profile are marked as shareable.

According to another aspect of the present application, a subset of attributes of the user profile are marked as non-shareable.

According to yet another aspect of the present application, a subset of attributes of the user profile are marked as being self-learning enabled.

According to still another aspect of the present application, the method includes publishing content created on the user terminal to the enterprise repository data store.

According to an aspect of the present application, the method includes restricting access to the content.

According to another aspect of the present application, the method includes categorizing the content at the user terminal based on predefined criteria.

According to yet another aspect of the present application, the method includes providing a uniform resource locator (URL) to the user terminal for performing management operations on the content, in which the management operations comprise: archival, deletion and format conversion.

According to still another aspect of the present application, the method includes querying a profile data store to determine a communication method for contacting a source owner of a subset of the content.

According to yet another aspect of the present application, the method includes initiating communication with the source owner, in which the communication includes the user profile.

According to still another aspect of the present application, the source owner determines whether to grant enhanced access privileges to a user based on the user profile.

According to an aspect of the present application, the communication is initiated without intervention by a user related to the user profile.

According to another aspect of the present application, the user profile is searchable.

According to yet another aspect of the present application, the content is pushed at predefined intervals.

According to still another aspect of the present application, the method includes selecting a delivery channel over which to receive the content.

According to an aspect of the present application, an enterprise knowledge management system for obtaining content includes a monitoring engine, implemented on at least one processor, that monitors at least one of an enterprise repository data store, an intranet, a local repository data store, the Internet and subscription-based sources to obtain data relevant to an enterprise profile. The system includes a content ingestion engine, implemented on the at least one processor, that categorizes, tags and indexes the data for storage in the enterprise repository data store. The system also includes a transmitter, implemented on the at least one processor, that pushes content selected based on a user profile, and obtained from the enterprise repository data store, to a user terminal.

According to an aspect of the present application, a tangible computer readable medium storing a computer program, recorded on the tangible computer readable medium, for obtaining content by an enterprise knowledge management system includes a monitoring code segment, recorded on the tangible computer readable medium, that monitors at least one of an enterprise repository data store, an intranet, a local repository data store, the Internet and subscription-based sources to obtain data relevant to an enterprise profile. The tangible computer readable medium includes categorizing, tagging and indexing the data for storage in the enterprise repository data store. The tangible computer readable medium includes pushing content selected based on a user profile, and obtained from the enterprise repository data store, to a user terminal.

According to one aspect of the present application, an enterprise knowledge management system (EKMS) supports a productive environment in which a user is apprised of relevant content related to a user profile, current projects and research activities.

According to another aspect of the present application, the enterprise knowledge management system enables users to accomplish the following types of tasks: discovering requirements for a current project based on related requirements for past projects; searching for related projects, policies, research information and people; and finding learning and training material from corporate learning resources.

According to yet another aspect of the present application, the enterprise knowledge management system provides integrated abilities to access and search for information from the Internet, a corporate intranet and from a local storage space. The enterprise knowledge management system also includes a publishing process to ensure confidentiality and privacy of each created content. The enterprise knowledge management system is implementable as part of a corporate structure, industry forum and social community.

According to one aspect of the present application, a comprehensive knowledge acquisition and delivery service infrastructure proactively provides information research contents to employees and project owners in an enterprise, based on the role, current (project) activities and special interests defined or learned based on individual user profiles or group profiles. A research integration tool and store integrates existing content creation tools, research results, and communication servers to improve productivity of an employee.

According to another aspect of the present application, an enterprise-wide information research management service layer automatically generates a profile for each user based on any of the following but not limited to: his or her role in an organization; active projects; and job/responsibility description. The enterprise-wide information research management service layer monitors information sources to proactively provide research notes, references and hints to a user (corresponding to a profile), even when the user does not initiate a “search” action. In one embodiment, the enterprise-wide information research management service layer enhances existing search-oriented results.

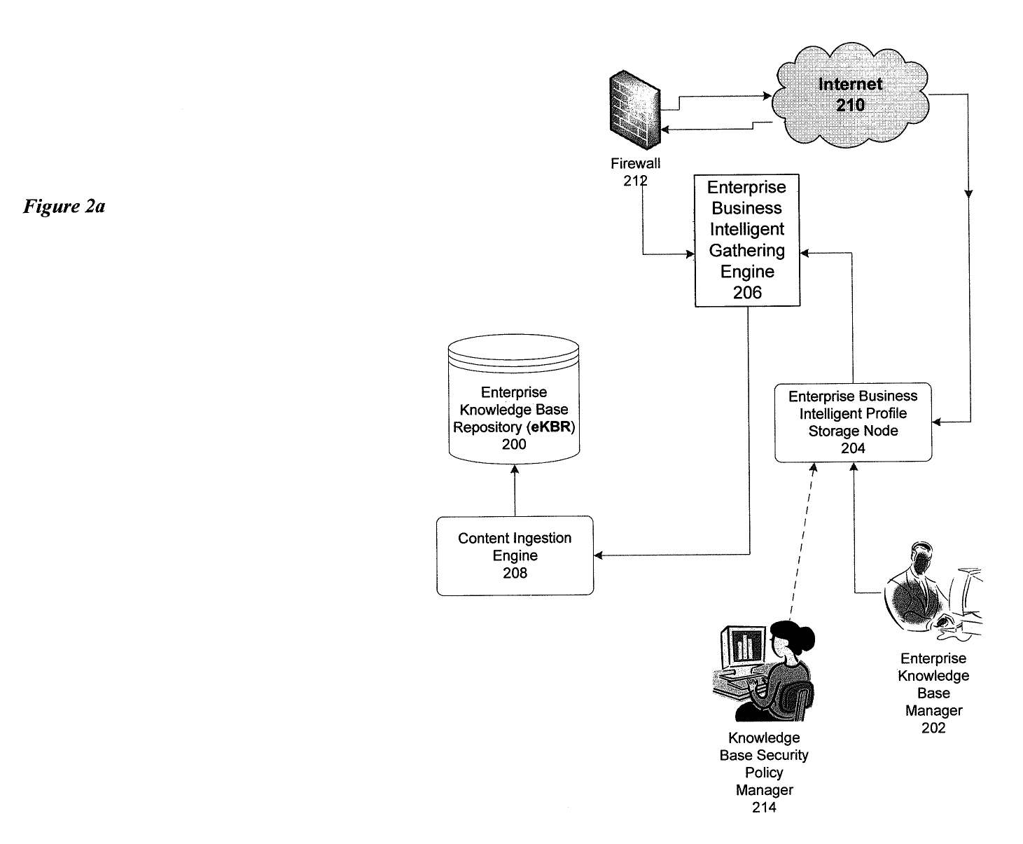

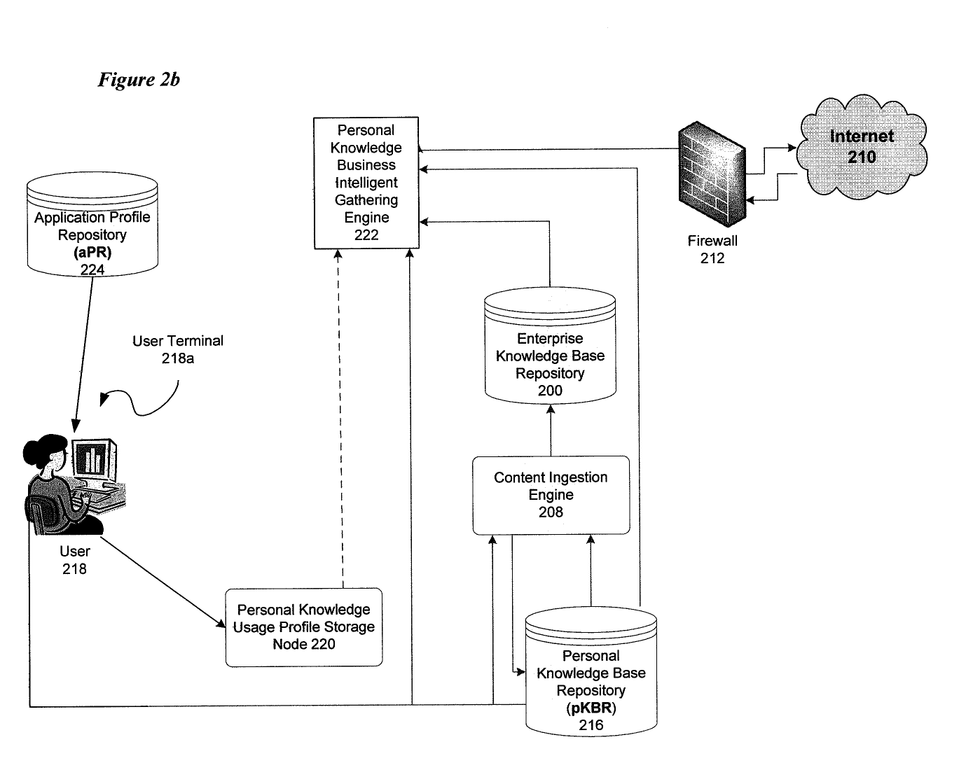

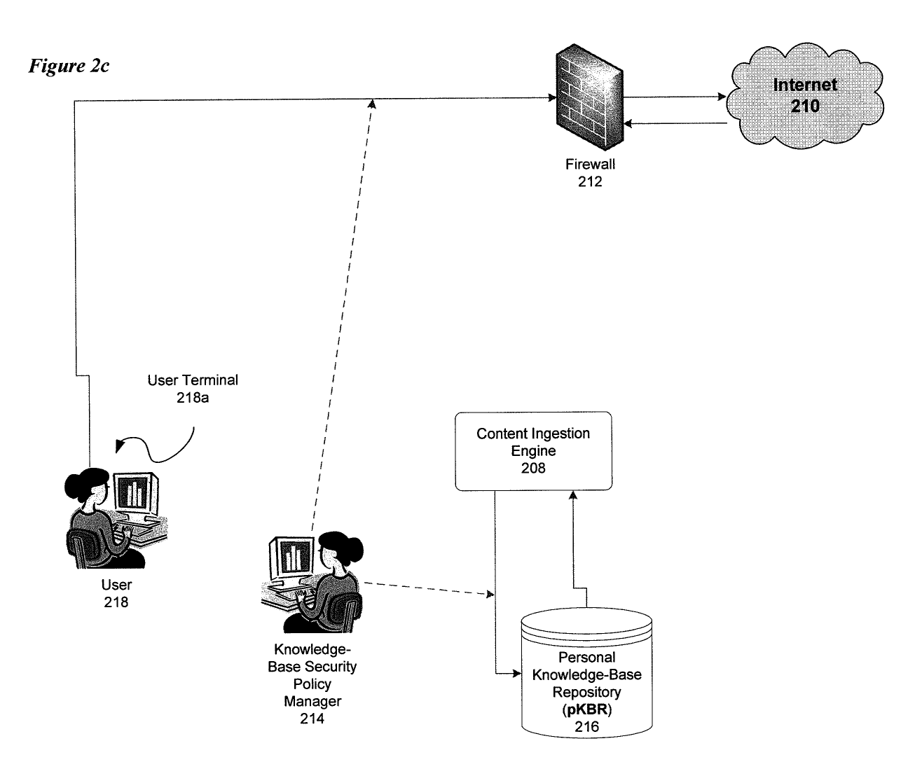

In FIG. 2a, a system diagram illustrating data flow among components involved in creating an enterprise knowledge base repository 200 is shown. An enterprise knowledge base manager 202 identifies and defines business intelligence domains that are relevant to an enterprise and creates an initial set of enterprise data-gathering categories, topics and subject areas and associated vocabulary (i.e., a taxonomy). In particular, the enterprise knowledge base manager 202 analyzes any of the following, but not limited to: the nature of the organization, competitive landscape, government regulations and market trends to define an enterprise knowledge base profile and identify sources of information, knowledge acquisition methods, information format, and acquisition frequency.

The enterprise knowledge base manager 202 is part of an information source layer, which is an abstraction including information sources from which information stored in the enterprise knowledge base repository 200 is obtained. The enterprise knowledge base manager 202 is either an automated or a human agent. The enterprise knowledge base manager 202 also evaluates external information sources and establishes arrangements (e.g., payment arrangements) to acquire content or a link to the content. Information sources include public information sources (e.g., obtained from the Internet, business intelligence subscription services and online books); internal information sources (e.g., company-specific information generated by enterprise employees having varying levels of internal confidentiality); and personal information sources (e.g., information focused on an individual roles, tasks and deliverables).

Further, the enterprise knowledge base manager 202 categorizes the above-described information obtained from the information sources. In one embodiment, the enterprise knowledge base manager 202 indexes and tags the above-described information. This information is used to determine an enterprise knowledge base profile (eKBP) that is stored on a enterprise business intelligent profile (eBIP) storage node 204. Accordingly, information obtained for and stored in the enterprise knowledge base repository 200 is based on the above-described enterprise knowledge base profile which is defined by the enterprise knowledge base manager 202. In one embodiment, a software monitoring agent continuously monitors the Internet, industry development and patent development information to alert the enterprise knowledge base manager 202 to acquire the information for storage in the enterprise knowledge base repository 200. The enterprise knowledge base repository 200 collects and protects information generated by users associated with the organization.

In one embodiment, the enterprise business intelligent profile is “self-learning”. That is, related information in the form of any of the following, but not limited to: subject area, topics, category, and business domains are extracted and learned from the Internet 210. Accordingly, the enterprise business intelligent profile is continuously updateable.

An enterprise business intelligent gathering engine (eBIGE) 206 acquires content from public and private information sources and channels, as discussed above, which include user-generated content, based on specifications in the enterprise business intelligent profile stored on the enterprise business intelligent profile storage node 204. The enterprise business intelligent gathering engine 206 retrieves filtered data from the enterprise business intelligent profile storage node 204. That is, the enterprise business intelligent gathering engine 205 retrieves shareable portions of the business intelligent profile, and not non-shareable portions of the business intelligent profile. The enterprise business intelligent gathering engine 206 automatically extracts information from the information sources discussed above, including the Internet 210, based on the enterprise business intelligent profile. In the illustrated embodiment, the Internet 210 is accessible via a firewall 212. The firewall 212 is implemented on a tangible physical device (not shown).

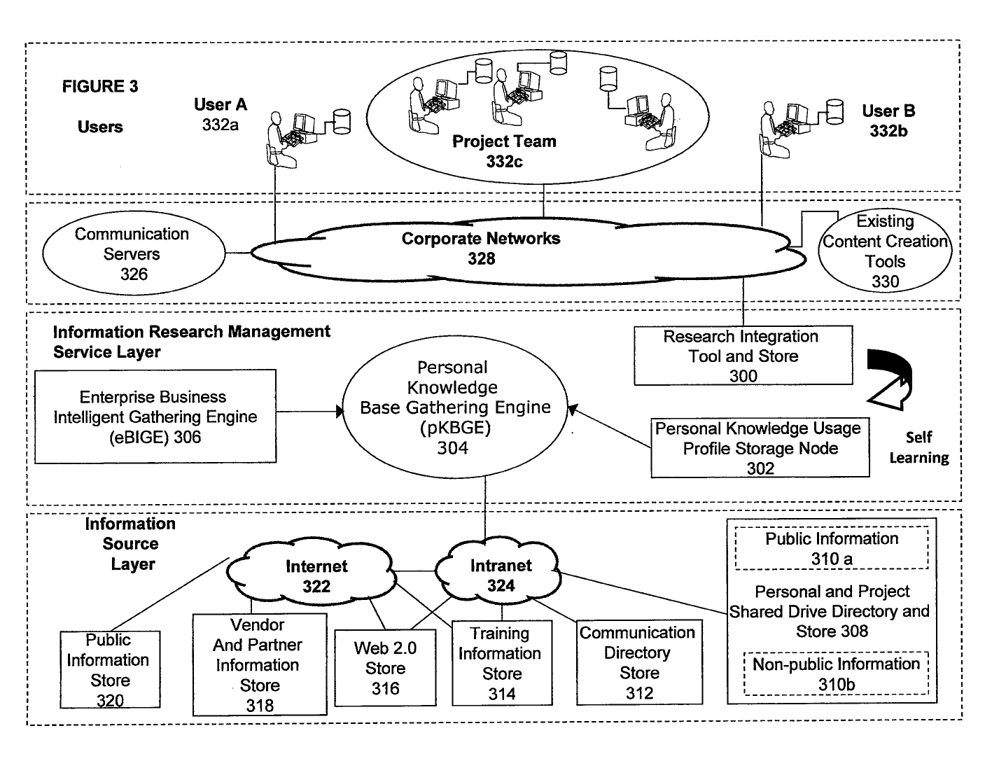

Each of the components illustrated in FIGS. 2a, 2b, 2c and 3 are implemented by at least one tangible physical device and optionally, one or more software components. The tangible physical device is any hardware component upon which a software application is implementable. For example, each of the illustrated firewalls, engines, stores, data stores, repositories, terminals and nodes include any of the following, but not limited to: a processor, a network element, a server, a computing device, a physical storage, database, data store and a physical memory. Additionally, the terms “content”, “pushed content”, “research information” and “research results” are used interchangeably hereinafter. Further, the terms “user profile”, “profile” and “personal knowledge usage profile” are used interchangeably hereinafter.

A content ingestion engine 208 “cleans” gathered content obtained from the enterprise business intelligent gathering engine 206. The content ingestion engine 208 verifies, error checks, catalogs, indexes and tags content obtained from the enterprise business intelligent gathering engine 206. Output from the content ingestion engine 208 is stored in the enterprise knowledge base repository 200. A knowledge base security manager 214 ensures organizational security policy enforcement and privacy guideline compliance on the part of the enterprise business intelligent profile 204.

In FIG. 2b, a system diagram for using the enterprise knowledge base repository 200 with a personal knowledge base repository (pKBR) 216 is shown. Information regarding any of the following, but not limited to: a user's job/responsibility description, a current assignment, a training plan and industry involvement, is used to generate a personal knowledge usage profile stored on a personal knowledge usage profile storage node 220 for a user 218 operating a user terminal 218a, which is further refineable by the user 218. For example, the user 218 refines his or her role and responsibilities with respect to various projects (e.g., by keyword and project name) and further, to specify contact information. The personal knowledge usage profile is adaptive and updateable based on a daily work product and research activities for the user 218. In one embodiment, the personal knowledge usage profile is updateable at predetermined time intervals. Further, features such as real-time update, on-demand update and requesting to reset a set of profiles are also supported. That is, for example, when a computer crashes, or when a user moves from one organization to another, sometimes the user's profile does not port, so a new profile is created. A personal knowledge usage profile is re-creatable and recoverable. In one embodiment, the user 218 resets his or her own profile. A personal knowledge usage profile also becomes part of “searchable knowledge”.

The personal knowledge usage profile is customizable or personalizable from an initial personal knowledge usage profile generated by, for example, the knowledge base security manager 214. The customized or personalized personal knowledge usage profile reflects current relevant subjects and current activities. The personal knowledge usage profile also captures real-time user behavior and analyzes current tasks to predict types of information and subject areas that the user 218 might be interested in. In one embodiment, the personal knowledge usage profile is used to determine whether there exists required training, for the user 218, in a specified subject area. Tutorial information is recommended based on a result of the determination.

Each user 218 subscribes to information in the enterprise knowledge usage profile stored in the enterprise knowledge usage profile storage node 204. The enterprise knowledge usage profile causes the enterprise knowledge management system to proactively “push” available information from the enterprise knowledge base repository and the Internet to the user's working environment to support his or her activities.

When the user 218 is online under predefined situations (e.g., a first login of the day, writing a report, designing a slide), a personal business intelligence gathering engine 222 fetches and filters a user's personal knowledge usage profile from the personal knowledge usage profile storage node 220. That is, the personal business intelligence gathering engine fetches the shareable, or non-private portions of the personal knowledge usage profile. The personal business intelligence gathering engine 222 searches for and extracts information relevant to the personal knowledge usage profile from the Internet 210, the enterprise knowledge base repository 200 and the personal knowledge base repository 216. The extracted information is proactively “pushed” to a graphical user interface on the user's terminal (i.e., a knowledge dashboard or a knowledge widget) to provide proactive, targeted content delivery.

In one embodiment, when it is determined that the pushed content is obtained from a specified information domain of too large a scope, the user 218 is prompted to provide a more detailed level of refinement (e.g., based on a requirement or architecture), such that a smaller set of content matching the personal knowledge usage profile is obtained. In one embodiment, the user 218 configures or selects “hot topics” on which they want to be alerted with updates. In another embodiment, alerts are deliverable to a mobile device, based on a location of the user 218. In one embodiment, access restrictions are based on a user profile and a location of the user 218 receiving the content and a type of device used to access the content. In yet another embodiment, the user 218 initiates a personalized knowledge base agent to monitor the user's current activity and provide information matches in a context-sensitive manner.

When the user 218 completes work (i.e., prepares a word processing document or a presentation), the user 218 has the option of storing the work in a private area (i.e., the personal knowledge base repository 216, as a default option) or to publish the work in a public area (i.e., the enterprise knowledge base repository 200). In one embodiment, the personal knowledge base repository 216 is a local hard drive. When the user 218 decides to publish work to the enterprise knowledge base repository 200, the content is forwarded to the content ingestion engine 208. As discussed above, the content ingestion engine 208 verifies, error checks, indexes and identifies a category associated with the content and sends the content to the enterprise knowledge base repository 200. The content prepared by the user 218 is indexed and categorized in the enterprise knowledge base repository 200, which enables other users to access the content generated by the user 218.

In one embodiment, the user 218 is enabled to move content to or remove from the enterprise knowledge base repository 200 at will. Locally stored work, that is, stored on the user's terminal, is indexable based on options specified in the personal knowledge usage profile. As discussed above, the personal knowledge base repository 216 is also used as a source for the personal knowledge base gathering engine 222. An application profile repository (aPR) 224 modifies notifications from applications (e.g., Microsoft Outlook) based on location. That is, the information provided to the user 218 is dependent on time and location parameters for the user 218. Moreover, files or output for specified applications are associated with messages pushed to the user 218.

In FIG. 2c, a system diagram illustrating components involved in publishing content to an area available to the public is shown. The knowledge base security policy manager 214 assists the enterprise knowledge base manager 202 to setup a channel to retrieve business intelligence from the Internet. As discussed above, the enterprise knowledge base manager 202 sets a policy for the publication and release of information to an intranet. The knowledge base security policy manager 214 reviews and approves the intranet information for publication to the Internet 210. In addition, the knowledge base security policy manager 214 reviews and sets each user's security classification profile and further, also sets rules to classify a security access level for content.

In one embodiment, local tools enable users to manage push-based contents. In another embodiment, an import tool assists in migrating contents to the enterprise knowledge base repository 200, as necessary. In yet another embodiment, each of the above-described options is configurable as either opt-in or opt-out. In still another embodiment, the enterprise knowledge management system keeps track of a document citing references and automatically generates a reference section (i.e., specifying bibliographic information for cited references) for the document.

In another embodiment, an originator of content marks a portion of the content as publicly (i.e., shareable) or partially publicly accessible (i.e., a combination of shareable and non-shareable portions). Requestors of the document request permission to access non-publicly accessible portions of the document in real-time.

In FIG. 3, a research integration tool and store 300 is shown in the enterprise knowledge management system diagram. The research integration tool and store 300 manages content pushed to a user A 332a (i.e., research results) corresponding to the user profile. The research integration tool and store 300 is implementable as an add-on module to content creation tools 330 to allow the user A 332a to access and incorporate “pushed” or searched for research information within an existing content creation environment (e.g., a word processing tool, an email client and an image processing application). As will be understood by one of ordinary skill in the art, content creation tools 330 are implemented on corresponding tangible physical devices, which are not shown in FIG. 3. The research integration tool and store 300 also triggers a self-learning capability of a personal knowledge usage profile storage node 302 in the information research management service layer.

As discussed with respect to FIG. 2b, the personal knowledge usage profile storage node 302 automatically creates a profile for each user by importing a job description/responsibility defined by a human resources (HR) department or the like, for an organization. A basic profile includes any of the following, but not limited to: employee name, email address, Q notification information and affiliated organization information. In one embodiment, the profile is implemented as a view of a communication directory store 312 in the information source layer. The user A 332a for which the personal usage knowledge profile is created requests, in one embodiment, that the personal knowledge usage profile storage node 302 generates a different level of project profile(s).

The personal knowledge usage profile is customizable by a user to include social parameters, special interests, project information, research topics, technical, administrative description, skill sets, industry forum involvement, publications, additional communication methods and social networking contact information. Each attribute added to the profile is designable as shareable or non-shareable data, by the user. When attributes related to a project are added to the profile, the user is permitted access to filtered views of personal and project shared drives in a personal and project shared drive directory and data store 308 in the information source layer. The personal and project shared drive directory and data store 308 includes public information 310a and non-public information 310b.

For each attribute in the profile, a self-learning option is configurable by the user. This option allows the profile to continue to gather updates based on “learned” information. For example, when a user adds a customized attribute in research topics with a keyword of “4G” and marks this attribute as self-learning, any content (e.g., a project, a search and a presentation) the user works on related to the topic “4G” is automatically added to the profile (e.g., WiMax, LTE, etc.).

The enterprise business intelligent gathering engine 306 “learns” and indexes content within the enterprise as well as external to the enterprise. The enterprise business intelligent gathering engine 306 complies with organizational security policy and privacy guidelines, as discussed above. Also as discussed above, when a content owner (e.g., employees, contractors, project managers) authors a document (e.g., a word processing document, a project plan, a presentation slide) using an existing content creation tool 330, the content owner selects a content sharing option in addition to marking it as requiring restricted access or as including proprietary information. Examples of the sharing option include restrictions based on: private to the organization, public outside the organization, members of a project team, same organization, a list of organizations, etc. Different portions of the document are designable using sharing options that are different from each other. For example, the sharing option for the body of a document is marked as “same organization” and the title of the document is marked with the sharing option “public”. In the exemplary case, content requestors outside of the organization are able to see the title but not the content.

When a sharing option is marked, enterprise business intelligent gathering engine 306 indexes and tag the title, the body or both of the document. The enterprise business intelligent gathering engine 306 indexes and tags content created externally by following organization security policy and privacy guidelines, of which external contents are discoverable using a search request or web-crawling based on predefined criteria.

When content is marked as being shareable, an index and/or tag is established by the enterprise business intelligent gathering engine 306, irrespective of where the content is physically located (e.g., on a local desktop for a user). Even when the content is marked as non-shareable, the content owner may still choose that the content be indexed so that he/she is enabled to leverage enterprise search capabilities to sort through contents within his/her control.

A personal knowledge business intelligence gathering engine 304 continuously evaluates each profile stored in the personal knowledge usage profile storage node 302 and creates a map to include content to which the user 332a or 332b associated with the personal knowledge usage profile is permitted to access, as defined in the enterprise business intelligence gathering engine 306. The personal knowledge business intelligence gathering engine 304 delivers discovered content, title index information and tag information to the user 332a or 332b based on a preferred notification method and a notification priority selected by the user. In one embodiment, the user uses a tool to assist in organizing research information. For example, the user may specify that all “LTE” related research results are to be moved to a “LTE Research Folder”. For time-sensitive content or for urgently required content, the user may specify a real-time or near real-time communication method (i.e., email or Q notification information) for any LTE training available within an enterprise or the industry near California. According to one aspect of the present application, it is not necessary to click a “search” button or affirmatively initiate a search. Research results are pushed to the user 332a, 332b, or 332c either on a periodic or random basis by the personal knowledge business intelligence gathering engine 304. In one embodiment, the personal knowledge business intelligence gathering engine 304 is operational twenty-four hours a day and seven days a week.

The research integration tool and store 300 provides integration utilities to allow a smooth integration with content creation tools 330. For example, if a content owner decides to use a word processing application to create a document for an LTE evaluation project, all LTE-related research content (including content originally created with a different content creation tool, i.e., content originally created with a slide presentation application) is accessible via the word processing environment.

Special utilities allows certain sections of a document to be created automatically and a historical trail to be recorded. In one embodiment, historical trail information is used for auditing or replay. The research integration tool and store 300 creates a virtual environment to receive or to view research results relevant to the user 332a or 332b associated with a profile or a project team associated with a project profile. This virtual environment resides on a user terminal or in the network and is seamlessly accessible by the user and has tools to categorize content. Content is categorizable on based on a project or profile

The research integration tool and store 300 also provides a portal which allows a user to interact with a single uniform resource locator (URL) for viewing and arranging research results. For example, research results for a specified topic, domain or project are grouped together in a directory. The portal also allows the user to manage research results using archival, deletion and format conversion management operations. The research integration tool and store 300 includes tracking and analytical capabilities. In one embodiment, the research integration tool and store tracks research activities for each profile owner. The analytical feature of the research integration tool and store enables user profiles and project profiles to be updated periodically.

The research integration tool and store 300 includes an auto-communicator feature. When a research result is obtained, the research integration tool and store 300 queries the personal knowledge usage profile storage node 302 to determine how the source owner specified communication options. In one embodiment, the research integration tool and store 300 initiates a communication attempt to inform the source owner that the user (i.e., the requestor of the content) wishes to access the content authored by the source owner. For example, if a research result is designated as having restricted access with the source owner's communication option specified as being an email notification, the research integration tool and store 300 initiates communication with the source owner, via email, and provides the requestor's profile, as an attachment to the email. This allows the source owner to determine if a special grant of access is to be provided to the requestor (i.e., the user requesting access to the content). In one embodiment, the communication is initiated without the requestor's intervention. In another embodiment, the communication is initiated without the requestor's knowledge.

The enterprise business intelligent gathering engine 306 tags and indexes content obtained from any of: public information store 320, vendor and partner information store 318, Web 2.0 store 316, training information store 314, communication directory store 312 and personal and project shared drive directory and store 308. Content indexing also occurs between user terminals for each of user A 332a, user B 332b and a project team 332c and the enterprise business intelligent gathering engine 306 and between the personal knowledge usage profile storage node 302 and the enterprise business intelligent gathering engine 306.

Content notification occurs by the personal knowledge base gathering engine 304 to the user A 332a, user B 332b and the project team 332c via either or both a corporate network 328 and the research integration tool and store 300. Profile customization is accomplished by the user A 332a, the user B 332b, and the project team 332c and the personal knowledge usage profile storage node 302. The personal knowledge usage profile storage node 302 has a logical data view of training information data store 314, communication directory 312 and the personal and project shared drive directory and store 308. Tool integration occurs between content creations tools 330 accessible by the user A 332, user B 332b and the project team 332c and the research integration tool and data store 300. Content creation occurs by the user A 332a, the user B 332b and the project team 332c using content creation tools (e.g., word processing, email clients and image processing applications). The personal knowledge usage profile storage node 302 accesses communications servers 326 to notify the user 332a, the user 332b or the project team 332c of another user requesting access to a document shared or authored by any of the above-described entities.

Accordingly, the present invention enables proactive discovery and delivery of personalized content to targeted enterprise users.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the invention in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, a project manager may be asked to assemble a technical team to launch a wireless service project in a short time period. The project manager creates a profile in the personal knowledge usage profile storage node 302. A list of qualified and available team member candidates are presented to the research integration tool and store 300, which communicates with these team member candidates directly to eliminate any unavailable candidates. A pre-screened list is presented to the project manger. The pre-screened list includes, for example, members available for the project, members available to act as consultants and experts but not available in a full-time capacity at the current time. In one embodiment, the Information Research Management Service Layer abstraction enables the personal knowledge usage profile storage node 302 to search for best potential candidates and to proactively notify candidates about job openings suitable for their skill set.

In step S400, the project manager creates a wireless service project profile and enters the requisite expertise in personal knowledge usage profile data store. In one embodiment, the project manager adds “team building” to the profile by selecting key words from a menu. In another embodiment, the project manager marks the profile as “private” such that the profile is not viewable via either a search action or a profile option. In step S402, the personal knowledge business intelligent gathering engine 304 initiates a research action when the profile created by the project manager is detected. In step S404, the enterprise business intelligent gathering engine 306 provides matching profiles (i.e., profiles having personal skill and interest attributes that match the profile created by the project manager) uniform resource locator data to the personal knowledge business intelligent gathering engine 304, which retrieves matching profile information containing either the matching expertise and/or special interest attributes. In step S406, the project manager and the research integration tool and store 300 are notified with a list of candidates along with associated profile information including communication information. In step S408, the research integration tool and store 300 performs an analysis and communicates with each candidate via the communication servers 326. Each candidate selects an available or an unavailable option. In step S410, a refined list including available candidates is sent to the project manager. In step S412, the project manager contacts the available candidates and selects a subset of the available candidates that are determined to be suitable for the project, and updates the profile with the information of the newly added team members. In step S414, the project manager and project team members receive research information, periodically, based on new team member attributes added by the project manager into the project profile or based on the new team members' updated personal knowledge usage profiles. If research results are suitable for integration, information will be accessible via a content creation tool environment.

In another example, a second user (Employee A) is assigned a feasibility study related to home wiring options to support future generation broadband services. When the second user adds attributes related to home wiring options to his profile, the second user is notified of a project cancelled four years ago prior to a merger activity and that specifies details of the project relevant to the second user. In step S500, a home wiring study project is cancelled due to a merger activity, the project team is dissolved and a first user (Employee B) migrates project documentation to the personal and project shared drive directory and store 308 by which the cancelled project documents are automatically indexed and tagged.

In step S502, the second user (Employee A) is assigned the same topic and creates a project profile in the personal knowledge usage profile storage node 302. Also in step S502, the personal knowledge business intelligent gathering engine 304 learns of the new profile and initiates a research action. In step S504, the enterprise business intelligent gathering engine 306 connects the personal knowledge business intelligence gathering engine 304 to information sources and the personal knowledge business intelligence gathering engine 304 obtains relevant research information from the personal and project shared drive directory and store 308. In step S506, the personal knowledge business intelligent gathering engine 304 obtains matched communication information from the communication directory store 312, based on the contact information listed in the obtained research information. In step S508, the second user (Employee A) is notified of project information and associated contact data. In one embodiment, the same information is delivered to the research integration tool and store 300 for tracking and integration. In step S510, the second user (Employee A) contacts the first user (Employee B) and to obtain additional information.

As another example, a first user (Employee A) chairs an Internet Protocol television (IPTV) standard group and creates and edits content related to the Internet Protocol television standard using existing content creation tools. In one embodiment, the content is marked as restricted and stored externally in an Internet Protocol television (IPTV) standard repository. A second user (Employee B) belongs to a different group and is editing another document which needs Internet Protocol television related references. The research integration tool and store 300 facilitates the search process, and triggers a notification to the first user (Employee A). The first user (Employee A) grants read access for relevant content to the second user (Employee B).

In step S600, a first user (Employee A) uses an existing content creation tool 330 to create and edit an Internet Protocol television standard document. The document is stored in a secured standard repository, and is accessible via the Internet by a user with specified access permissions. Also in step S600, the first user (Employee A) provides a uniform resource locator and marks the content as restricted. In step S602, the document is discovered and indexed by the enterprise business intelligent gathering engine 306. In step S604, the first user (Employee A) selects shareable and non-shareable options, for the project and associated document, in a profile. If the first user (Employee A) does not mark any information as non-shareable in the profile, this information is discovered when the content is searched for. In step S606, a second user (Employee B), who works in a different organization (but the same enterprise) creates a document via an existing content creation tool 330 and decides to create a reference to the Internet Protocol television standard. Also in step S606, the second user (Employee B) invokes a keyword search (e.g., IPTV standard document) via the research integration tool and store 300. The second user (Employee B) continues to edit of the document. In step S608, access to a searched for document is denied but critical attributes (e.g., author and abstract) are passed to the personal knowledge business intelligent gathering engine 304. In step S610, the content owner's profile (Employee A) is searched and his/her communication attributes are fetched. In addition, the training information store 314 as well as Web 2.0 information store 316 is also searched. In step S612, the research integration tool and store 300 receives research results and detects that a targeted document is marked as having restricted access. The research integration tool and store 300 checks Employee A's communication option and sends an email or other communication (e.g., Q notification, chat client message, voicemail) to the first user (Employee A) to request grant of read access. In step S614, the first user (Employee A) reads the second user's (Employee B's) profile and grants read access by clicking, for example, a “grant permission” button in the email. In step S616, the research integration tool and store 300 fetches the first user's (Employee A's) Internet Protocol television standard document and alerts Employee B via the integration feature. Accordingly, Employee B is provided read access to the Internet Protocol television standard document.

As yet another example, a first user (Employee A) creates an Internet Protocol television related document and stores it on the personal and project shared drive directory and store 308. A second user (Employee B) learns of the existence of the document from the personal knowledge business intelligent gathering engine 394 and chooses to add it to the reference section of his or her document. Insofar as the second user's (Employee B's) document is a “working document”, he or she selects an “auto-update” option. Some time later, the first user (Employee A) establishes a new version of the Internet Protocol television document. The second user's (Employee B's) document is updated with new information corresponding to the new version of the Internet Protocol television document.

In step S700, a first user (Employee A) uses an existing content creation tool to create and edit an Internet Protocol television document. The document is stored in the personal or project shared drive directory and store, which is accessible via Intranet with a person having the appropriate access permissions. This document is classified as a “shareable” public document. In step S702, the document is discovered by the enterprise business intelligent gathering engine 306. In step S704, a second user (Employee B) creates a working document and initiates an “IPTV document” search. In step S706, the research integration tool and store 300 updates the second user's (Employee B's) research attributes in a personal knowledge usage profile stored on the personal knowledge usage profile storage node 302 and requests an on-demand search action to be performed, which results in finding the first user's (Employee A's) document. In step S708, the document authored by the first user (Employee A) is fetched from the personal and project shared drive directory and store 308 and is provided, along with a uniform resource locator, to the research integration tool and store 300. In step S710, the research information (i.e., the fetched document) is provided to the content creation tool 330. Also in step S710, the second user (Employee B) reads the fetched document and maps the fetched document to the reference section of his or her in-progress document and selects an “auto update” option. In step S712, the first user (Employee A) makes a substantive revision of the Internet Protocol television document and the personal and project shared drive directory and store 308 is updated and the document is re-indexed and retagged. In step S714, the updated information is sent to the personal knowledge business intelligent gathering engine 304. Relevant profiles are fetched and a new version of the document is retrieved and notification is sent to the research and integration tool and store 300. In step S716, because Employee B selected an AUTO Update option, information related to the new version of the document is sent to the content creation tool 330 at which the reference section is updated automatically.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present specification describes components and functions that may be implemented in particular embodiments with reference to particular standards and protocols, the disclosure is not limited to such standards and protocols. For example, standards for Internet and other packed switched network transmission represent examples of the state of the art. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method of obtaining content by an enterprise knowledge management system, comprising:
monitoring at least one of an enterprise repository data store, an intranet, a local repository data store, the Internet and subscription-based sources to obtain data relevant to an enterprise profile;
categorizing, tagging and indexing the data for storage in the enterprise repository data store; and
pushing content selected based on a user profile, and obtained from the enterprise repository data store, to a user terminal.

2. The method according to claim 1,
wherein the user profile is automatically generated, and
wherein the user profile is based on a job description and contact information for a user.

3. The method according to claim 2,
wherein the user profile is customizable by a user.

4. The method according to claim 1, further comprising:
displaying the content, as part of a graphical user interface, on the user terminal.

5. The method according to claim 1,
wherein a subset of attributes of the user profile are marked as shareable.

6. The method according to claim 1,
wherein a subset of attributes of the user profile are marked as non-shareable.

7. The method according to claim 1,
wherein a subset of attributes of the user profile are marked as being self-learning enabled.

8. The method according to claim 1, further comprising:
publishing content created on the user terminal to the enterprise repository data store.

9. The method according to claim 8, further comprising:
restricting access to the content.

10. The method according to claim 1, further comprising:
categorizing the content at the user terminal based on predefined criteria.

11. The method according to claim 1, further comprising:
providing a uniform resource locator (URL) to the user terminal for performing management operations on the content,
wherein the management operations comprise: archival, deletion and format conversion.

12. The method according to claim 1, further comprising:
querying a profile data store to determine a communication method for contacting a source owner of a subset of the content.

13. The method according to claim 12, further comprising:
initiating communication with the source owner,
wherein the communication includes the user profile.

14. The method according to claim 13,
wherein the source owner determines whether to grant enhanced access privileges to a user based on the user profile.

15. The method according to claim 13,
wherein the communication is initiated without intervention by a user related to the user profile.

16. The method according to claim 1,
wherein the user profile is searchable.

17. The method according to claim 1,
wherein the content is pushed at predefined intervals.

18. The method according to claim 1, further comprising:
selecting a delivery channel over which to receive the content.

19. An enterprise knowledge management system for obtaining content, comprising:
a monitoring engine, implemented on at least one processor, that monitors at least one of an enterprise repository data store, an intranet, a local repository data store, the Internet and subscription-based sources to obtain data relevant to an enterprise profile;
a content ingestion engine, implemented on the at least one processor, that categorizes, tags and indexes the data for storage in the enterprise repository data store; and
a transmitter, implemented on the at least one processor, that pushes content selected based on a user profile, and obtained from the enterprise repository data store, to a user terminal.

20. A tangible computer readable medium storing a computer program, recorded on the tangible computer readable medium, for obtaining content by an enterprise knowledge management system, comprising:
a monitoring code segment, recorded on the tangible computer readable medium, that monitors at least one of an enterprise repository data store, an intranet, a local repository data store, the Internet and subscription-based sources to obtain data relevant to an enterprise profile;
a categorizing code segment, recorded on the tangible computer readable medium, that categorizes, tags and indexes the data for storage in the enterprise repository data store; and
a pushing code segment, recorded on the tangible computer readable medium, that pushes content selected based on a user profile, and obtained from the enterprise repository data store, to a user terminal.
